(19) United States
(12) Patent Application Publication
(10) Pub. No.: US 2012/0158302 A1
(43) Pub. Date: Jun. 21, 2012

(54) LIGHT INTENSITY MEASUREMENT APPARATUS

(75) Inventor: HONG-RU ZHU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/980,344

(22) Filed: Dec. 29, 2010

(30) Foreign Application Priority Data
Dec. 17, 2010 (CN) 201010593931.9

(51) Int. Cl. G06F 19/00; G01J 1/00

(52) U.S. Cl. 702/1; 356/213

(57) ABSTRACT

A light intensity measurement apparatus includes a universal serial bus (USB) interface, a number of light sensors, and a micro control unit (MCU). The USB is operable to be connected to a computer. The light sensors are operable to sense light signals and convert the sensed light signals to corresponding electrical signals. The MCU is operable to receive the electrical signals and convert the electrical signals to USB data signals, and then transmit the USB data signals to the computer through the USB interface.

### BACKGROUND

1. Technical Field

The present disclosure relates to a light intensity measurement apparatus.

2. Description of Related Art

To test some light-emitting components, such as light-emitting diodes, a method uses a specialized light intensity tester to test light intensity of a light-emitting component. However, the specialized light intensity tester is very expensive.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, schematic view of an embodiment of a light intensity measurement apparatus.

FIG. 2 is a block diagram of the light intensity measurement apparatus of FIG. 1, together with a computer.

FIGS. 3 and 4 are circuit diagrams of the light intensity measurement apparatus of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

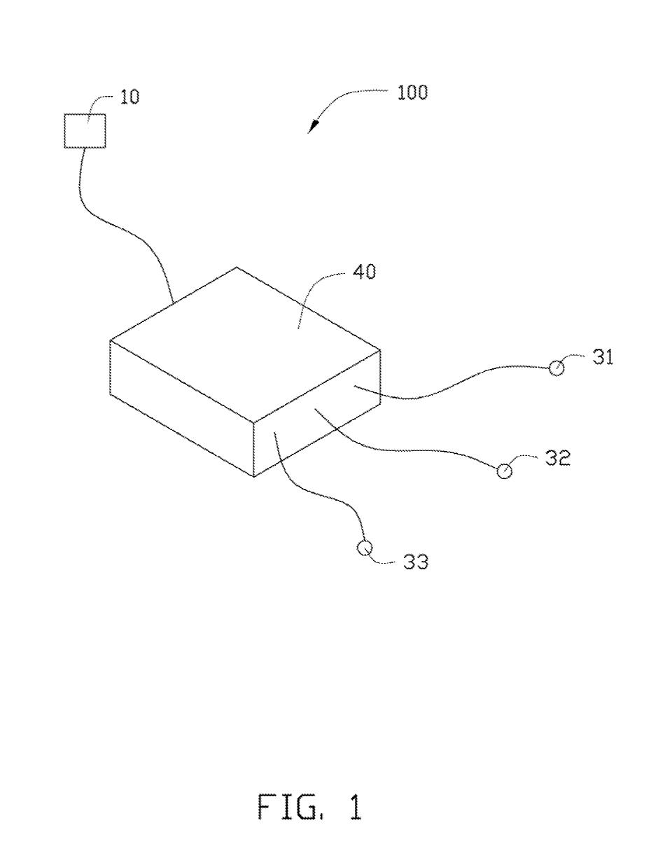

Referring to FIG. 1, an embodiment of a light intensity measurement apparatus 100 includes a case 40, and a universal serial bus (USB) interface 10 and first to third light sensors 31-33 connected to the case 40 by cables.

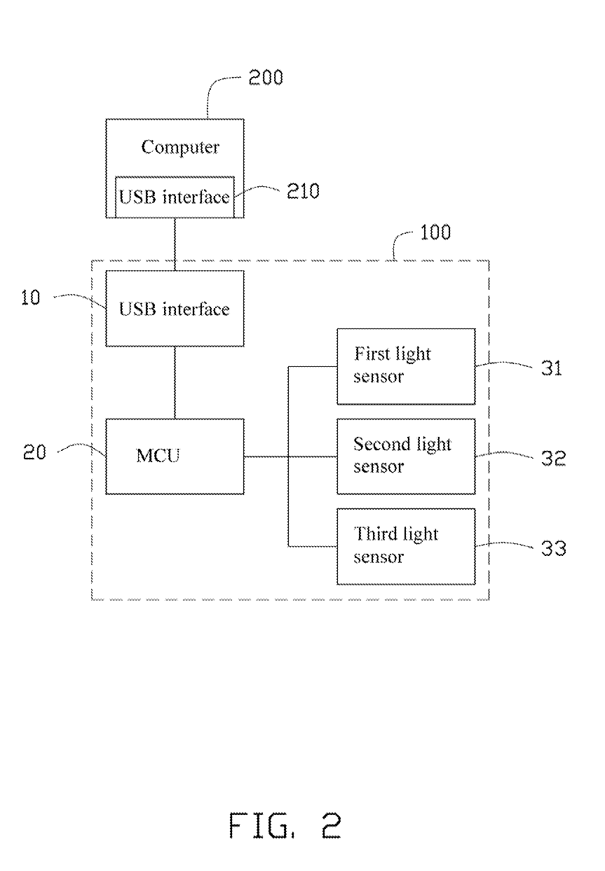

Referring to FIG. 2, the light intensity measurement apparatus 100 further includes a micro control unit (MCU) 20 arranged in the case 40. In other embodiments, the USB interface 10, the first to third light sensors 31-33, and the MCU 20 also can be arranged on a circuit board (not shown). The number of the light sensors can be changed according to requirements.

The MCU 20 is electrically connected between the USB interface 10 and the first to third light sensors 31-33. The USB interface 10 is used to be connected to a USB interface 210 of a computer 200. In use, the USB interface 10 is connected to the USB interface 210 of the computer 200. The MCU 20 and the first to third light sensors 31-33 receive a 5 volt (V) power signal from the computer 20 through the USB interfaces 210 and 10, therefore the MCU 20 and the first to third light sensors 31-33 can work. The first to third light sensors 31-33 are positioned at predetermined places near a light-emitting component (not shown) to sense light signals of the light-emitting component. The first to third light sensors 31-33 convert the sensed light signals to corresponding electrical signals, and then transmit the electrical signals to the MCU 10. The MCU 10 receives the electrical signals and converts the electrical signals to USB data signals, and transmits the USB data signals to the computer 200. The computer 200 receives the USB data signals and calculates light intensity of the light-emitting component through corresponding software, which falls within well-known technologies, and is therefore not described here. Therefore, the apparatus 100 together with a computer, which is commonly used at test stations anyway, and replaces the specialized, expensive light intensity tester, which can save testing costs.

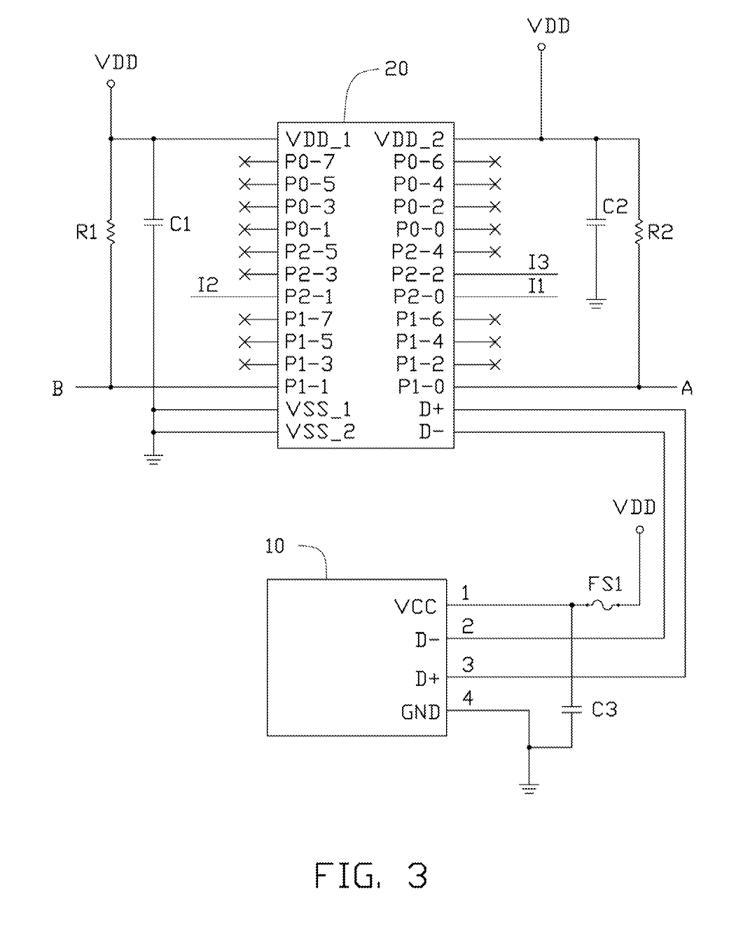

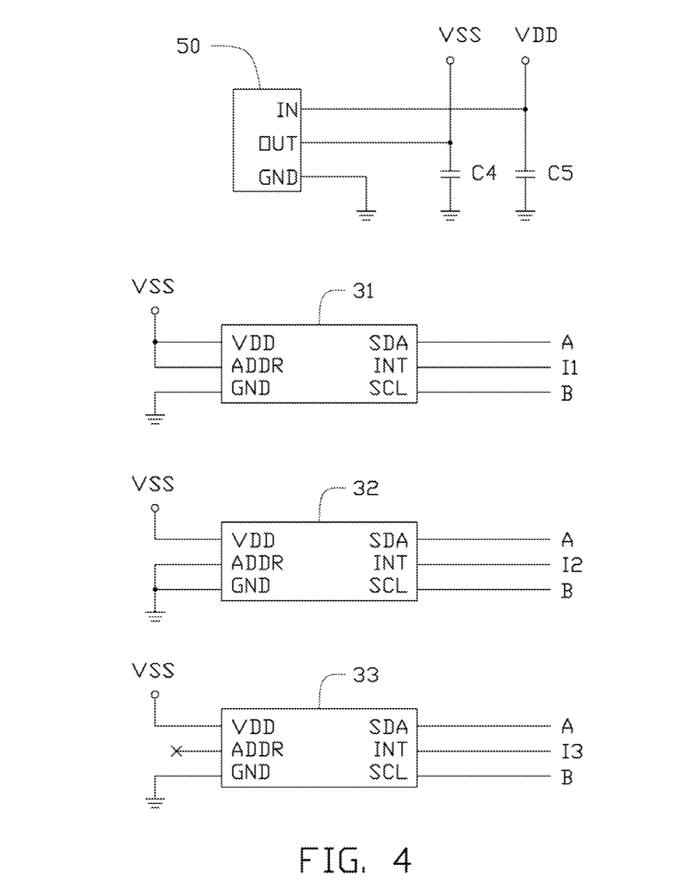

Referring to FIGS. 3 and 4, in one embodiment, the MCU 20 is a CY7C64215-28PVXC MCU, and the first to third light sensors 31-33 are TSL2563CS light sensors. In this embodiment, a voltage convertor 50, such as an LD1117AS33TR voltage convertor, is provided to convert 5V output by the USB interface 10 to 3.3V to power the TSL2563CS light sensors.

The USB interface 10 includes a voltage terminal VCC, two data terminals D− and D+, and a ground terminal GND. The voltage terminal VCC is connected to power pins VDD_1 and VDD_2 of the MCU 20, and a voltage input terminal IN of the voltage convertor 50 through a fuse FS1. The data terminals D− and D+of the USB interface 10 are respectively connected to two date output pins D− and D+ of the MCU 20. The ground terminal GND of the USB interface 10 is grounded. The voltage terminal VCC of the interface 10 is also grounded through a capacitor C3.

The power pins VDD_1 and VDD_2 of the MCU 20 are respectively grounded through a capacitor C1 and a capacitor C2. Power pins VSS_1 and VSS_2 of the MCU 20 are grounded. The power pin VDD_1 of the MCU 20 is connected to a data input pin P1-1 of the MCU 20 and clock pins SCL of the first to third light sensors 31-33 through a resistor R1. The power pin VDD_2 of the MCU 20 is connected to a data input pin P1-0 of the MCU 20 and data pins SDA of the first to third light sensors 31-33 through a resistor R2. Data input pins P2-0, P2-1, P2-2 of the MCU 20 are respectively connected to interrupt pins INT of the first to third light sensors 31-33.

An output terminal OUT of the voltage convertor 50 is connected to power pins VDD of the first to third light sensors 31-33. A ground terminal GND of the voltage convertor 50 is grounded. The output terminal OUT and the input terminal IN are grounded respectively through two capacitors C4 and C5. In other embodiments, if the first to third light sensors 31-33 are a kind of sensor that operates on 5V, the voltage convertor 50 can be omitted to save cost, and the power terminal VCC of the USB interface 10 is then directly connected to the power pins VDD of the first to third light sensors 31-33 through the fuse FS1.

Ground pins GND of the first to third light sensors 31-33 are grounded. An address pin ADDR of the first light sensor 31 is connected to the power pin VDD of the first light sensor 31, namely the address pin ADDR of the first sensor 31 is in a high voltage state. An address pin ADDR of the second light sensor 32 is grounded, namely the address pin ADDR of the second light sensor 32 is in a low voltage state. An address pin ADDR of the third light sensor 33 is idle, namely the address pin ADDR of the third light sensor 33 is in an idle state. Therefore, the first to third light sensors 31-33 have different address parameters, which can be distinguished by the MCU 20.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A light intensity measurement apparatus comprising:
a universal serial bus (USB) interface operable to be connected to a computer;
a plurality of light sensors operable to sense light signals and convert the sensed light signals to corresponding electrical signals; and
a micro control unit (MCU) operable to receive the electrical signals and convert the electrical signals to USB data signals, and then transmit the USB data signals to the computer through the USB interface.

2. The light intensity measurement apparatus of claim 1, wherein a voltage terminal of the USB interface is connected first and second power pins of the MCU and power pins of the plurality of light sensors, two data pins of the USB interface are respectively connected to two data output pins of the MCU, the first power pin of the MCU is connected to a first date input pin of the MCU and clock pins of the plurality of light sensors through a first resistor, the second power pin of the MCU is connected to a second data input pin of the MCU and data pins of the plurality of light sensors through a second resistor, interrupt pins of the plurality of light sensors are respectively connected to a plurality of third data input pins of the MCU.

3. The light intensity measurement apparatus of claim 2, wherein the number of the plurality of light sensors is three, which are first to third light sensors, an address pin of the first light sensor is connected to the power pin of the first light sensor, an address pin of the second light sensor is grounded, and an address pin of the third light sensor is idle.

4. The light intensity measurement apparatus of claim 2, further comprising a voltage convertor connected between the voltage terminal of the USB interface and the power pins of the plurality of light sensors.

5. The light intensity measurement apparatus of claim 2, further comprising a fuse connected between the voltage terminal of the USB interface and the first and second power pins of the MCU.
